(19) United States
(12) Patent Application Publication
(10) Pub. No.: US 2006/0063024 A1
(43) Pub. Date: Mar. 23, 2006

(54) Metallized substrate

(75) Inventors: Masuhiro Natsuhara, Itami-shi (JP); Hirohiko Nakata, Itami-shi (JP); Fumio Otsuji, Itami-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi (JP)

(21) Appl. No.: 11/222,037

(22) Filed: Sep. 9, 2005

(30) Foreign Application Priority Data
Sep. 21, 2004 (JP) 2004-272709

(51) Int. Cl. C25D 1/08; B21D 39/00; B32B 15/04; C03C 27/02

(52) U.S. Cl. 428/621; 428/627; 428/632; 428/596

(57) ABSTRACT

The present invention provides a metallized substrate that has little warping and a fine, smooth surface. In the metallized substrate of the present invention, a conductive film is formed by spraying on the surface of a ceramic substrate or a composite substrate of a ceramic and a metal. The surface roughness of the conductive film formed by the spraying is preferably Ra≦1.0 μm. The surface of the conductive film may be a machined surface. The spraying is preferably arc spraying, plasma spraying, or flame spraying.

### TECHNICAL FIELD

The present invention relates to a metallized substrate wherein a conductive film is formed on the surface of a ceramic substrate or a composite substrate of a ceramic and a metal, and the surface is made fine and smooth. The present invention further relates to a heating device that uses this metallized substrate and that is used in semiconductor manufacturing devices or semiconductor testing devices. The present invention still further relates to wafer probers, handlers, and testers and the like on which such heating device is mounted.

### BACKGROUND ART

In the prior art, a heat treatment is conducted on a semiconductor substrate (wafer) as a workpiece during a testing step for a semiconductor. In other words, the wafer is heated to a higher temperature than the usual usage temperature, so that any semiconductor chips which have the possibility of failing are made to fail at an accelerated rate and are removed. This is a burn-in step, which is conducted to prevent the occurrence of failure after shipping. In the burn-in step, after forming a semiconductor circuit on the semiconductor wafer and prior to cutting the individual chips, the electrical performance of each chip is measured while the wafer is being heated. In this manner, any defective products are removed.

With this burn-in step, a heater is used to hold the semiconductor substrate and to heat the semiconductor substrate. With the heaters of the prior art, such as the one shown in Japanese Patent Application Publication No. 01-315153, for example, the entire undersurface of the wafer must be in contact with the ground electrode. As a result, metallic heaters are used.

Japanese Patent Application Publication No. 2001-135685 discloses the practice of forming a porous metal layer on a ceramic substrate and using it in a wafer prober. It is stated that this invention enables a relatively thin prober because ceramics are less susceptible to deformation than metal.

In Japanese Patent Application Publication No. 2001-135685, a method of attaching a paste of a metal powder onto a ceramic substrate by baking is employed. However, when the paste of a metal powder is baked onto the ceramic substrate, there is a problem in that the substrate becomes warped due to contraction in the volume of the metal powder from baking, and the difference in the coefficients of thermal expansions of the metal and the ceramic. If the substrate becomes warped, a workpiece such as a semiconductor, for example, cannot be mounted in close contact with the substrate. If a workpiece cannot be mounted in close contact with the substrate, where the substrate is to be used as a wafer prober, for example, there is a problem in that the workpiece cannot be adequately fixed in place by suction. Furthermore, even if the workpiece is successfully fixed in place by suction, when a probe card is pressed against the workpiece, there are sections in the workpiece with which the probe pin cannot come into contact, or the workpiece is damaged.

Also, it is possible to form a plating layer on the surface of the ceramic substrate to form a metallized layer. However, if there are any pores or projections on the surface of the ceramic, the plating layer that is formed accentuates the shapes of the pores or projections. In other words, projections on the ceramic substrate cause the plating film to have larger protruding shapes. Also, a plating film cannot be formed in large pores easily, and therefore pinholes tend to be formed. Furthermore, there is also a problem that the thickness of the metal layer cannot be increased with a metal paste or plating or the like.

### DISCLOSURE OF INVENTION

The present invention was designed in order to solve above described problems. Specifically, an object of the present invention is to provide a metallized substrate that has little warping, and has a dense, smooth surface.

The metallized substrate of the present invention is characterized in that a conductive film is formed by spraying on the surface of a ceramic substrate or a composite substrate of a ceramic and a metal. The surface roughness of the conductive film formed by spraying is preferably Ra≦1.0 μm. The surface of the conductive film may be a machined surface. The spraying used is preferably arc spraying, plasma spraying, or flame spraying.

The main components of the conductive film is preferably any one or more of nickel, aluminum, copper, titanium, stainless steel, gold, platinum, and silver.

The conductive film is preferably formed by layering two or more thermally sprayed films. Also, the conductive film is preferably subjected to a heat treatment after being formed, and the atmosphere of the heat treatment is preferably a nonoxidizing atmosphere.

The main component of the ceramic substrate is preferably any one of aluminum nitride, aluminum oxide, silicon nitride, or silicon carbide. Also, the composite of the ceramic and the metal is preferably a composite of silicon carbide and aluminum, or silicon and silicon carbide.

A plating layer is preferably formed on the conductive film, and the surface roughness of the plating layer is preferably Ra≦1.0 μm. Furthermore, a through-hole is preferably formed in the substrate, and a groove may also be formed in the substrate.

Furthermore, a conductive layer is preferably formed on a surface of the substrate opposite the surface on which the conductive film is formed or in the interior of the substrate. Furthermore, this conductive layer is preferably a heating element.

Such a metallized substrate is preferably used in a semiconductor manufacturing device or a semiconductor testing device, and is particularly preferably used in a wafer prober for heating and testing wafers.

### BRIEF DESCRIPTION OF DRAWINGS

FIG. 1 shows one example of the cross-sectional construction of a metallized substrate of the present invention;

FIG. 2 shows another example of the cross-sectional construction of a metallized substrate of the present invention; and

FIG. 3 shows one example of a heating element circuit pattern of the present invention.

### BEST MODE FOR CARRYING OUT THE INVENTION

The inventors have discovered, as a result of earnest research on methods for obtaining a warp-free metallized substrate, that it is possible to obtain a metallized substrate with almost no warping if a conductive film is formed by spraying on a ceramic substrate or a composite substrate of a ceramic and a metal.

Since spraying essentially involves spraying droplets of conductive material, it is possible to reduce the number of pores in the conductive film formed. The resulting advantages are that the surface of the sprayed conductive film can be made smooth, and even when a smooth surface is not obtained initially, a smooth surface can be obtained after the surface is subjected to a polishing process or the like.

When a metal paste is baked, pores or air bubbles are present in the metal layer due to the fact that a metal powder is baked. Therefore, pores cannot be removed even when the surface is polished, and it has been difficult to obtain a metallized substrate having a smooth surface. If such a metallized substrate is used as a heater for heating a semiconductor wafer, for example, the semiconductor wafer cannot be heated uniformly because the transfer of heat from the heater to the semiconductor wafer is hindered by the pores. In the case of spraying, however, the wafer can be uniformly heated because there are virtually no pores.

The substrate used in the present invention is a ceramic substrate or a composite substrate of a ceramic and a metal. These materials are less susceptible to deformation than metals because their Young's moduli are high. Therefore, when such substrate is used as a wafer prober, for example, the prober can be relatively thin.

Also, the surface roughness Ra of the thermally sprayed conductive film is preferably 1.0 μm or less. This is because when the metallized substrate is used as a prober, for example, the surface roughness Ra is 1.0 μm or less, the semiconductor wafer, which is a workpiece, and the metallized surface can be satisfactorily brought into close contact. Although the surface roughness Ra of the surface of the thermally sprayed conductive film can be made 1.0 μm or less if the spraying conditions are optimized, the surface roughness Ra often exceeds 1.0 μm since spraying generally uses aggregated metal particles. In this case, the surface roughness Ra can be decreased to 1.0 μm or less by polishing the surface of the thermally sprayed conductive film. The polishing process is the same as the process of polishing metal, and therefore the surface roughness Ra can be decreased to 0.2 μm or less by decreasing the size of the polishing abrasive grains, for example. If the surface roughness Ra is 0.2 μm or less, the semiconductor wafer and the metallized substrate can be brought into close contact with virtually no gaps, in the aforementioned case of a prober, for example. Also, the pores in the thermally sprayed conductive film preferably have a porosity of 5% or less. If the porosity exceeds 5%, pinholes and other such defects are likely to result on the surface even after the polishing process.

Although there is in principle no limitation in the spraying method of the present invention, arc spraying, plasma spraying, or flame spraying is preferable. In arc spraying, two wire rods are eclectically communicated at the nozzle portion which is at the distal end of a spray gun. The wire rods are melted by the arc heat that is generated by the short circuiting at the point of intersection between the two wire rods. Then, melted droplets are miniaturized and sprayed with compressed air. Therefore, relatively large compression strength can be achieved in the droplets relative to the substrate, and a thermally sprayed film that bonds well with the substrate can be obtained.

There are two types of plasma spraying, namely, low-pressure plasma spraying and atmospheric pressure plasma spraying. Low-pressure plasma spraying involves temporarily venting the air inside a chamber, filling the chamber with argon or another such inert gas at a reduced pressure, adjusting the atmosphere, and then conducting plasma spraying. In the plasma spraying, the temperature of the gas is increased, the gas molecules are separated into atoms, and a high-temperature, high-speed gas jet of convergent gas (plasma) of electrons and cations that were further ionized, in other words a plasma jet, is used to melt and spray a powdered material. Since in the low-pressure plasma, the spraying is conducted in a chamber with an adjusted atmosphere, a film can be formed from a metal with relatively high activity, such as titanium. Also, since the speed of the sprayed particles is relatively high compared to spraying in the atmosphere, a sprayed film that is finer and has greater bonding strength can be obtained. In the atmospheric-pressure plasma spraying, the spraying plasma is conducted in the atmosphere, and therefore is less expensive than the low-pressure plasma spraying.

Also, the flame spraying includes high-speed flame spraying, wire flame spraying, and powder flame spraying. In the high-speed flame spraying, high speed flames are produced by increasing the pressure in the combustion chamber of a spraying gun. Powdered material is supplied to the middle of the jet flow of the combustion flames to render the powdered material in a melted or half-melted state. Then, the material is sprayed out continuously at high speeds. Since the sprayed material collides with the substrate at ultrasonic speeds in this method, an extremely fine film with high bonding strength can be formed. Also, in the wire flame spraying, a wire of metal or an alloy is melted and sprayed to form a film on a substrate using as a heat source flames of combustible gas such as oxygen and acetylene or propane. This method can be applied to various materials, from materials with relatively low melting point such as aluminum and zinc, for example, to materials with relatively high melting point such as copper, stainless steel, and molybdenum, for example. Since this method is commonly performed in the atmospheric conditions, the resulting film contains an oxide, nitride, or the like. Thus, the film thus obtained tends to have a higher degree of hardness than the starting material. Therefore, the resulting film has relatively superior abrasion resistance. Also, in the powder spraying, a powder material is melted and sprayed to form a sprayed film on the substrate surface using as a heat source flames from combustible gas such as oxygen and acetylene or propane. In this method as well, the film tends to contain oxide, nitride, or the like, and the film tends to have a higher degree of hardness than the starting material.

The material of the conductive film to be formed on the surface of the substrate can be any material having a liquid phase. Particularly suitable are nickel, aluminum, copper, titanium, stainless steel, gold, platinum, and silver. In the case of nickel, a slightly oxidized film is formed on the surface of the droplets during spraying.

This oxidized film bonds with the oxidized film on the substrate surface, thereby achieving a relatively high bonding strength.

In the case of aluminum, an oxide, an oxynitride, or a nitride is formed on the surfaces of the droplets during spraying. This oxide, oxynitride, or nitride can enable a particularly high bonding strength, especially when the substrate is an aluminum compound or a silicon compound. For example, when the substrate is alumina, excellent bonding strength can be obtained because the substrate easily bonds with the aluminum oxide, namely, the alumina, on the surfaces of the droplets. When the substrate is aluminum nitride, a thin film of aluminum oxynitride or aluminum oxide is formed in addition to the aluminum nitride on the surface of the aluminum nitride, due to the reaction with the oxygen in the atmosphere. This film reacts easily with the oxide, oxynitride, or nitride on the surfaces of the aluminum droplets, and a particularly high bonding strength can be achieved. The bonding strength is similarly high when the substrate is aluminum oxynitride.

Furthermore, when the substrate is a silicon compound, silicon oxide is present on the surface of the silicon compound. The silicon oxide and the aluminum oxide react very readily, and depending on the ratio of aluminum to silicon, a mullite phase, cordierite phase, or steatite phase is formed, and a high bonding strength can be easily achieved. Also, silicon nitride and aluminum oxide or oxynitride react and form so-called Sialon, thereby achieving a high bonding strength.

Because of these, where the material of the conductive film is aluminum, materials of the substrate that achieve superior bonding strength include alumina, aluminum nitride, aluminum oxynitride, silicon, silicon carbide, a composite of silicon carbide and aluminum or silicon, silicon nitride, Sialon, mullite, cordierite, steatite, and the like.

Relatively high bonding strength can also be ensured when copper is the material of the conductive film. The surfaces of the droplets of copper sprayed during the spraying contain Cu₂, CuO, or another such oxide. It is believed that this oxide reacts with the oxide present in the substrate surface, and the copper adheres firmly to the substrate.

Also, the copper oxide readily forms eutectic crystals, particularly with aluminum oxide or silicon oxide. Therefore, when the substrate contains an aluminum or silicon compound, a firm coupling can be achieved through the formation of eutectic crystals. Accordingly, stronger bonding can be achieved.

Thus, when the material of the conductive film is copper, the same materials can be used as the materials of the substrate that enable high bonding strength as the case where the material of the conductive film is aluminum. Also, copper and aluminum are so-called soft metals. Thus, the conductive film and the substrate are not subject to much stress and can be used satisfactorily even if there is a considerable difference in the coefficient of thermal expansion between the film and the substrate, or even when a heat cycle is applied, because the conductive film is highly deformable.

Titanium is excellent as a material for the conductive film from the point of view of the ability to allow close contact between the substrate and the conductive film. Titanium bonds extremely well regardless of what material the substrate is made from. However, since titanium oxidizes very easily, the low-pressure plasma spraying is suitable as the method for spraying.

Furthermore, stainless steel also exhibits relatively high adhesiveness as the material for the conductive film. This is presumably because of the effects of nickel, chrome, or other such metals contained in stainless steel. In the case of nickel, a relatively high bonding strength can be achieved because oxides of nickel react with the substrate as described above. Chrome is a relatively active metal, although not as much as titanium is, and can bond to a substrate relatively firmly regardless of the material the substrate is made of.

Also, gold, platinum, and silver are metals with excellent oxidation resistance even at high temperatures. However, gold, platinum, and silver are metals with poor reactivity, and a high bonding strength cannot be obtained even if they are sprayed directly onto various substrates. Therefore, these metals are effective with either a substrate containing metal or a substrate on which a titanium film or other such metallic film is formed in advance. Excellent bonding strength can be achieved by directly bonding gold, platinum, silver, or another such metal with the metal contained in the substrate or with a titanium film or other such film.

In the present invention, the thickness of the conductive film is not particularly restricted. However, if the conductive film has one layer, the surface area of the substrate exceeds 300 mm in terms of diameter, and no stress reduction measures are taken, then when the metallized substrate is repeatedly used at temperatures of 200° C. or less, the thickness of the conductive film is preferably 1.0 mm or less. When the metallized substrate is repeatedly used at temperatures of 400° C. or less, the thickness of the conductive film is preferably 0.3 mm or less. A conductive film with a thickness of 1.0 mm or greater or 0.3 mm or greater will sometimes peel off when subjected to heat cycles, in which the temperature is repeatedly varied between room temperature and the aforementioned temperatures. However, if the conductive film has two or more layers and stress reduction measures of forming grooves or the like in the conductive film are taken, then it is possible to ensure that the conductive film will not peel off even if the thickness is greater than the aforementioned thicknesses.

Fashioning the conductive film in two or more layers makes it possible to obtain a conductive film that adheres well with the substrate and has excellent oxidation resistance and corrosion resistance. For example, if the substrate is alumina, aluminum nitride, aluminum oxynitride, silicon, silicon carbide, a composite of silicon carbide and aluminum or silicon, silicon nitride, Sialon, mullite, cordierite, steatite, or the like, either aluminum or copper is first sprayed to form the conductive film. Strong adhesiveness with the substrate can be achieved in this conductive film as described above. However, the surface of aluminum or copper oxidizes relatively easily. Thus, when the conductive film is used in a wafer prober, for example, the surface thereof gradually oxidizes during its use, and the electrical conductivity between the wafer and the conductive film deteriorates.

In view of this, by spraying nickel, gold, platinum, silver, or another such metal with excellent oxidation resistance onto aluminum or copper, it is possible to prevent deterioration of the electrical conductivity during use. Since nickel, gold, platinum, and silver can be bonded with aluminum or copper with high bonding strength, it is possible to obtain a conductive film that adheres well to the substrate and has excellent oxidation resistance.

Also, aluminum and silver are soft metals. Therefore, even if nickel, stainless steel, or another such relatively hard metal is sprayed on, since aluminum and copper are capable of deformation, it is possible to obtain a conductive film that is not prone to peeling even if the conductive film is subjected to a heat cycle or the like.

Titanium can be used instead of aluminum or copper. Since titanium is an extremely active metal as previously described, there is a merit that there is no limitation in the material for the substrate. If nickel, gold, platinum, silver, or another such metal is sprayed after the titanium is first sprayed, a conductive film with excellent adhesiveness and oxidation resistance can be obtained. However, costs are somewhat higher because the titanium must be sprayed by the low-pressure plasma spraying. Therefore, if the substrate material contains aluminum or silicon, costs can be reduced by using aluminum or copper.

The combination of materials in the conductive film is not limited to the combinations given above, and various combinations can be used depending on the application. For example, if nickel is first sprayed and gold, platinum, silver, or the like is sprayed thereon, it is possible to obtain a conductive film that has oxidation resistance even at a high temperature of 400° C. or greater. Various combinations can be used for the conductive film depending on the type of the substrate, the temperature at which it is used, the atmosphere in which it is used, the usage, and so on.

After the conductive film is formed, the electrical conductivity of the conductive film can be improved by a heat treatment in a nonoxidizing atmosphere. If the spraying is performed under the atmospheric conditions, oxides form in the conductive film. These oxides contribute to an increase in bonding strength between the substrate and the conductive film as previously described, but the oxides located in areas other than those near the boundary with the substrate do not contribute to improving the bonding strength with the substrate. Since oxides have poor electrical conductivity, and particularly since the oxides in the conductive film surface reduce the electrical conductivity between the conductive film and the wafer, it is preferable to remove the oxides. The oxides can be removed to improve the electrical conductivity in the conductive film by the heat treatment in a nonoxidizing atmosphere, as previously described.

The nonoxidizing atmosphere may be nitrogen, argon, or the like. It is particularly preferable to use hydrogen because hydrogen has a high ability to remove oxygen in the conductive film. Also, if nitrogen, argon, hydrogen, or another such gas is used, the dew point of the gas is preferably −30° C. or less. If a gas with a dew point exceeding −30° C. is used, the conductive film may be oxidized.

Also, the temperature of the heat treatment is preferably between 300° C. and the melting point of the conductive film. At a temperature of less than 300° C., the oxygen is not removed efficiently. At a temperature equal to or greater than the melting point of the conductive film, the conductive film melts and peels.

The material of the substrate can be alumina, aluminum nitride, aluminum oxynitride, silicon, silicon carbide, a composite of silicon carbide and aluminum or silicon, silicon nitride, Sialon, mullite, cordierite, steatite, or the like. The ceramic is preferably aluminum nitride, aluminum oxide, silicon nitride, or silicon carbide. These ceramics have a higher Young's modulus than those of metals. Thus, when such ceramics are used as a prober, for example, the substrate is less likely to deform when the probe card is pressed against the wafer. Particularly, silicon carbide and aluminum nitride have high thermal conductivity, and therefore the temperature distribution of the substrate can be reduced when the substrate is heated. Also, silicon nitride can be made thinner because of its high mechanical strength. Furthermore, aluminum oxide is inexpensive. Since these materials contain aluminum or silicon, a high bonding strength can be achieved with a sprayed film of aluminum or copper.

Also, as the composite of ceramics and metal for the substrate material, a composite of silicon carbide and aluminum, or a composite of silicon carbide and silicon is preferred. Since these composites have high thermal conductivity and a high Young's modulus, when the substrate is used as a prober, for example, these composites can form a substrate with reduced thickness and excellent uniformity in temperature.

Also, a plating film can be formed on the conductive film (sprayed film) that is formed on the substrate. If a material with poor oxidation resistance such as aluminum and copper is used as the sprayed film, oxidation of the sprayed film can be prevented if a metal with excellent oxidation resistance such as silver is used as the plating. The thickness of the plating film is not particularly limited, but is preferably 0.1 μm or greater. If the thickness is less than 0.1 μm, it is difficult to prevent oxidation in the sprayed film. The thickness of the plating film is preferably 1.0 μm or greater because there is then no occurrence of discoloration or the like.

Plating can also be performed after the sprayed film is polished. In this case, the plating is preferably reduced in thickness as much as possible. This is because thick plating results in poor surface roughness even if the surface of the sprayed film is made smooth by polishing. For example, where a sprayed aluminum film of a thickness of 200 μm is formed, the film is finished by polishing such that a surface roughness Ra is about 0.1 μm, and where nickel plating is formed with a thickness of 10 μm, then the surface roughness Ra will be about 0.3 μm. If the thickness of the nickel plating is 5 μm or less, the surface roughness changes very little.

Also, it is possible to polish after the plating to improve the surface roughness after the plating. In this case, it is preferable to perform polishing after setting the plating thickness to 5 μm or greater, and preferably 20 μm or greater. If the thickness is less than 5 μm, there is a possibility that the plating film will be removed by polishing and the sprayed film underneath will become exposed.

Also, a through-hole is preferably formed in the metallized substrate. If the metallized substrate is used as a prober, for example, the through-hole can be a hole for vacuum suction for fixing the wafer in place. It is preferable to form a plurality of through-holes in order to reliably fix the wafer in place.

Furthermore, if grooves are formed in a concentric pattern, a spiral pattern, a radial pattern, or a grid pattern on the surface of the substrate on which the conductive film is formed (metallized surface), and if through-holes are formed in the grooves, then the wafer can be more reliably fixed in place when the wafer is fixed by vacuum suction.

Also, the degree of flatness of the metallized substrate is preferably 0.5 mm or less. This is because when the metallized substrate is used as a wafer prober, for example, if the degree of flatness exceeds 0.5 mm, then gaps form between the wafer and the metallized surface. Accordingly, the vacuum suction strength decreases, and it is difficult to reliably fix the wafer in place.

Also, a semiconductor layer can be formed either on the surface opposite the side of the substrate on which the conductive film is formed (metallized surface), or in the interior of the substrate. If a conductive layer is formed either on the surface opposite the metallized surface or in the interior of the substrate, a slight warping of the substrate resulting from spraying can be further reduced. Particularly when the metallized substrate of the present invention is used in an application in which the metallized substrate is subjected to heat cycles repeatedly between high and low temperatures, the warping of the metallized substrate tends to gradually increase in the absence of a conductive layer. This increase in the warping can be reduced if the conductive layer is formed in advance.

This conductive layer can be formed, for example, by adding a small amount of a metal oxide powder and a binder to a metal powder, forming the powder mixture into a paste, applying the paste by screen printing or another such method, and baking the paste. Metals with high melting points such as tungsten, molybdenum, and tantalum, and precious metals such as silver, gold, palladium, and platinum can be used as such metals of the paste.

When the conductive layer is applied by screen printing or another such method and is baked, the substrate sometimes becomes warped after baking. Thus, if a conductive layer is to be formed, the conductive film is preferably formed after polishing the surface on which the conductive film is to be formed, preferably to a degree of flatness of 0.5 mm or less, after the conductive layer is formed by spraying.

Also, when the substrate is electrically conductive, the conductive layer is preferably formed after an insulating layer is formed in advance. This is because the conductive layer short-circuits if an insulating layer is not formed. The insulating layer can be formed by printing and baking glass, or spraying an insulating material. Glass can be ZnO, B₂O₃, SiO₂, Al₂O₃, or other rare earth oxides, nitrides of aluminum or silicon, alkaline-earth metal oxides, lead oxide, or the like. The glass can be formed by adding a solvent or binder to these powders, forming a paste, applying the paste by screen printing or the like, and baking the paste.

When the insulating layer is formed by spraying, alumina, mullite, cordierite, steatite, or any other such insulating materials that are capable of being sprayed can be used as the insulating layer, without any particular restrictions. The baking temperature or the melting point of the insulating layer must be higher than the baking temperature of the conductive layer to be formed thereafter, regardless of whether the insulating layer is glass or a sprayed film.

Also, the conductive layer can be formed by attaching a foil of steel or an alloy of nickel and chrome. When the substrate is made of an insulating material, the metal foil can be directly fixed in place with screws or the like, or can be fixed in place by being directly pressed on with an insulating sheet of resin, glass, ceramics, or mica, for example. If the substrate is electrically conductive, the metal foil can be sandwiched between such insulating sheets. Also, the metal foil can be formed by bonding with a resin. In this case, resin can be an epoxy resin, a phenol resin, a silicon resin, a fluorine resin, or the like.

These resins should be appropriately selected according to the temperature at which they are used, their heat resistance, and the environment in which they are used. A filler can also be mixed in with these resins. The thermal conductivity of the bonding layer is improved by mixing in a filler. Thus, when the conductive layer is a heat generating element, the heat generated by the conductive layer can be quickly transferred to the substrate, and a metallized substrate with excellent responsiveness can be obtained. This way, when the conductive layer is formed by attaching a metal foil, warping of the substrate due to the formation of the conductive layer can be minimized because there is no baking step.

Also, when the conductive layer is to be formed in the interior of the substrate, the layer can be formed by providing a plurality of green sheets of the substrate material, coating the surfaces thereof with the metal paste by screen printing or another such method, and stacking, degreasing, and baking the green sheets as necessary. The conductive layer can also be formed by preparing a plurality of substrates, coating the surfaces thereof with the metal paste, baking the coated substrates, and then laminating the substrates together. Materials for the bonding layer used to laminate the substrates can be ZnO, B₂O₃, SiO₂, Al₂O₃, or other such rare earth oxides, nitrides of aluminum or silicon, alkaline-earth metal oxides, lead oxide, or the like. The substrates can be applied by adding a solvent or binder to these powders, forming them into a paste, applying the paste by screen printing, and then baking the paste.

The conductive layer is preferably a heat generating element. If the metallized substrate of the present invention is used as a wafer prober, for example, the wafer is sometimes heated to about 200° C., for example, in order to test the wafer. By using the conductive layer for reducing the warping of the substrate doubles as a heat generating element for heating, it is possible to dispense with the need to form additional circuits.

The metallized substrate of the present invention can be appropriately used for heating and testing workpieces such as wafers. It is particularly preferable if the metallized substrate is used in a wafer prober, a handler device, or a tester device, because its characteristics such as high rigidity and high thermal conductivity can be useful.

### EMBODIMENT 1

Substrates of aluminum nitride (AlN), silicon nitride (Si₃N₄), silicon carbide (SiC), alumina (Al₂O₃), a composite of aluminum and silicon carbide (Al—SiC), and a composite of silicon and silicon carbide (Si—SiC) were provided, each with a diameter of 330 mm and a thickness of 5 mm. The amount of warping in each of these substrates was 10 μm or less. A conductive film with a diameter of 310 mm and a thickness of 50 μm was formed in the middle of one side of these substrates by the wire flame spraying of aluminum (Al), nickel (Ni), copper (Cu), and stainless steel (SUS), and then an increase in the warping of the surface of the conductive film (in units of μm) was measured.

For the sake of comparison, a silver paste was prepared by mixing together 90 wt % of silver powder, 5 wt % of platinum powder, 2 wt % of ZnO2 powder, 2 wt % of B₂O₃ powder, and 1 wt % of SiO₂ powder, and adding an organic solvent and a binder. A coating of this silver paste (Ag) was applied by screen printing to the middle of one side of each of the substrates so as to have a diameter of 310 mm and a thickness of 50 μm, and was baked at 850° C. under atmospheric conditions to form conductive films. An increase in the warping (μm) on the surfaces of these conductive films was then measured. The results are shown in Table 1.

TABLE 1

| Substrate Material | Al | Ni | Cu | SUS | Ag |
|---|---|---|---|---|---|
| AlN | 2 | 3 | 3 | 4 | 45 |
| Si₃N₄ | 2 | 2 | 3 | 3 | 25 |
| SiC | 2 | 2 | 2 | 3 | 30 |
| Al₂O₃ | 3 | 3 | 2 | 4 | 40 |
| Al—SiC | 3 | 4 | 4 | 3 | — |
| Si—SiC | 2 | 2 | 3 | 3 | 30 |

As can be seen from Table 1, if a conductive film is formed by spraying, the increase in warping is extremely small regardless of the material of the conductive film. In contrast, if the silver paste is baked as in the conventional practice, the increase in warping is extremely large. With Al—SiC in particular, since the aluminum melted, therefore the warping could not be measured.

### EMBODIMENT 2

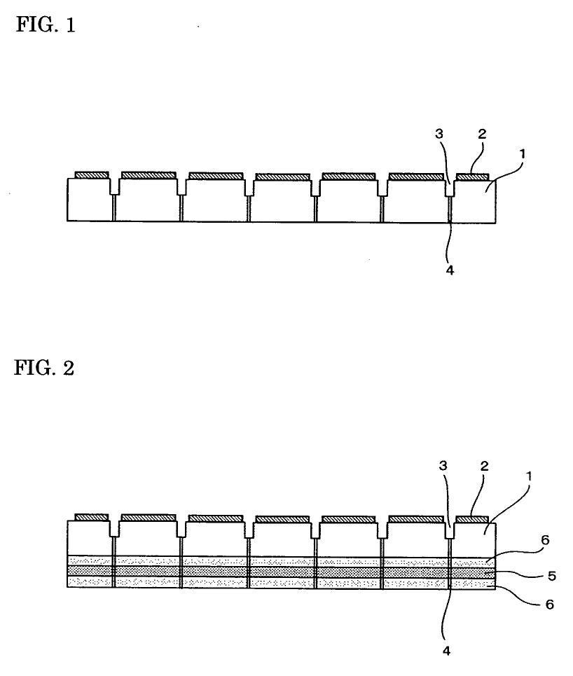

The substrates of Embodiment 1 having sprayed aluminum were provided. As shown in FIG. 1, three circular grooves 3 with respective diameters of 250 mm, 150 mm, and 50 mm were formed 2 mm wide and 2 mm deep by mechanical processing on the surface of an aluminum conductive film 2 formed on a substrate 1. Through-holes 4 were formed in these circular grooves. Four through-holes were formed in the groove with the diameter of 250 mm, three were formed in the groove with the diameter of 150 mm, and two were formed in the groove with the diameter of 50 mm to allow vacuum suction from the opposite side.

The surface of the conductive film was polished to varying degrees of surface roughness (Ra), and the suction properties of the wafer were examined. The results are shown in Table 2. In evaluating the suction properties, the sign ⊚ indicates that the suction property was very good and that sufficiently close contact was maintained even one minute after the completion of the vacuuming, the sign ◯ indicates the suction property was good and that close contact was maintained during vacuuming, and the sign X indicates that the suction property was poor and that the wafer could be moved by hand even during vacuuming.

TABLE 2

| Substrate | Ra | Suction | Ra | Suction | Ra | Suction |
|---|---|---|---|---|---|---|
| Material | (μm) | property | (μm) | property | (μm) | property |
| AlN | 0.15 | ⊚ | 0.87 | ◯ | 1.57 | X |
| Si₃N₄ | 0.17 | ⊚ | 0.82 | ◯ | 1.46 | X |
| SiC | 0.18 | ⊚ | 0.96 | ◯ | 1.81 | X |
| Al₂O₃ | 0.12 | ⊚ | 0.77 | ◯ | 1.43 | X |
| Al—SiC | 0.17 | ⊚ | 0.69 | ◯ | 1.78 | X |
| Si—SiC | 0.20 | ⊚ | 1.0 | ◯ | 1.62 | X |

As can be seen from Table 2, the wafer could be sufficiently suctioned if the surface roughness Ra of the conductive film was 1.0 μm or less, and an even more satisfactory suctioning condition could be achieved if Ra was 0.2 μm or less.

### EMBODIMENT 3

Twenty μm of nickel plating was applied on the conductive films of the metallized substrates used in Embodiment 2, and the surfaces of the nickel plating layers were polished to achieve the surface roughness values (Ra) shown in Table 3. The wafer suction properties were then examined, as in Embodiment 2. The results are shown in Table 3. The symbols are similar to those in Table 2.

TABLE 3

| Substrate | Ra | Suction | Ra | Suction | Ra | Suction |
|---|---|---|---|---|---|---|
| Material | (μm) | property | (μm) | property | (μm) | property |
| AlN | 0.13 | ⊚ | 0.84 | ◯ | 1.49 | X |
| Si₃N₄ | 0.18 | ⊚ | 0.91 | ◯ | 1.68 | X |
| SiC | 0.17 | ⊚ | 1.0 | ◯ | 1.88 | X |
| Al₂O₃ | 0.20 | ⊚ | 0.90 | ◯ | 1.47 | X |
| Al—SiC | 0.13 | ⊚ | 0.78 | ◯ | 1.71 | X |
| Si—SiC | 0.18 | ⊚ | 0.64 | ◯ | 1.79 | X |

As can be seen from Table 3, even when plating is applied to the conductive film, the wafer can be adequately suctioned if the surface roughness Ra of the plating is 1.0 μm or less, and an even more preferable suctioning condition can be achieved if Ra is 0.2 μm or less.

### EMBODIMENT 4

Metallized substrates in which 50 μm of aluminum was sprayed onto AlN substrates were provided, as in Embodiment 1. Nickel plating was applied on the aluminum conductive films, as in Embodiment 3. The thicknesses of the nickel plating were varied from 0.05 μm to 10 μm, as shown in Table 4. These metallized substrates and a substrate with no nickel plating were placed in a desiccator at 200° C., and it was determined whether there was any change in outward appearance and in electrical conductivity.

For electrical conductivity, a tester was lightly pressed against the metallized surface, and conduction was determined at ten arbitrary points. Instances in which there was no conduction at any point, or instances in which the resistance value was extremely high, were concluded to represent unsatisfactory conduction. All of the metallized substrates prior to this test had resistance values of either 0 Ω or 0.1 Ω.

These results are shown in Table 4. In Table 4, the sign ◯ indicates that there was either no or little discoloration and that conduction was satisfactory, the sign Δ indicates that conduction was satisfactory but discoloration occurred partially, and the sign X indicates that conduction was partially unsatisfactory.

TABLE 4

| Plating | Before | After 1 | After 10 | After 50 | After 100 |
|---|---|---|---|---|---|
| thickness (μm) | test | hour | hours | hours | hours |
| None | ◯ | Δ | X | X | X |
| 0.05 | ◯ | Δ | Δ | X | X |
| 0.1 | ◯ | ◯ | Δ | Δ | Δ |
| 0.5 | ◯ | ◯ | ◯ | Δ | Δ |
| 1.0 | ◯ | ◯ | ◯ | ◯ | ◯ |
| 5.0 | ◯ | ◯ | ◯ | ◯ | ◯ |
| 10.0 | ◯ | ◯ | ◯ | ◯ | ◯ |

As can be seen from Table 4, if the thickness of the nickel plating was 0.1 μm or greater, there were no occurrences of unsatisfactory conduction, and a stable metallized film with no discoloration could be obtained at 1.0 μm or greater.

### EMBODIMENT 5

Metallized substrates in which circular grooves and through-holes were formed, similar to those of Embodiment 2, were prepared. Also, stainless foil having 20 μm thickness was etched to form a predetermined heat generating circuit pattern. As shown in FIG. 2, the stainless steel foil 5 with the aforementioned pattern, which is a heat generating element, was sandwiched between mica sheets 6, and was fixed with stainless steel screws (not shown) to the surface of the metallized substrate opposite the side on which the conductive film 2 was formed. Also, a stainless steel foil with a heat generating circuit pattern was screwed on to each the metallized substrates of Embodiment 1 except for the one with silver.

These were installed in a testing device as wafer probers, silicon wafers having a diameter of 300 mm were vacuum suctioned, and the silicon wafers were tested at a temperature of 200° C. The temperature was increased to 200° C. by electrically energizing the stainless steel foil. As a result, it was possible to conduct normal testing with all of the metallized substrates.

Furthermore, with regard to the metallized substrates in which circular grooves and through-holes were formed, the temperature distribution at 200° C. was measured using a wafer thermometer equipped with a temperature-measuring resistance, and the difference between the maximum and minimum values was defined as a measure of heating uniformity. Also, a change (increase) in the warping of the metallized substrates at room temperature and at 200° C. was measured using a laser displacement gauge. For the sake of comparison, the substrates with no stainless steel foil were heated to 200° C. with a halogen lamp, and the temperature distributions and an increase in the warping were measured. Furthermore, the substrates with stainless steel foil were heated with a halogen lamp, and their temperature distributions and an increase in the warping were measured. The results are shown in Table 5.

TABLE 5

| | With heat | | | | | |
|---|---|---|---|---|---|---|
| | generating | | Without heat | | | |
| | element | | generating | | | |
| | Heating | | element | | Halogen heating | |
| | uni- | Warp- | Heating | Warp- | Heating | Warp- |
| Substrate | formity | ing | uniformity | ing | uniformity | ing |
| material | (° C.) | (μm) | (° C.) | (μm) | (° C.) | (μm) |
| AlN | 0.45 | 2 | 0.62 | 12 | 0.61 | 3 |
| Si₃N₄ | 0.63 | 2 | 1.03 | 11 | 0.99 | 2 |
| SiC | 0.44 | 2 | 0.59 | 12 | 0.57 | 3 |
| Al₂O₃ | 0.77 | 3 | 1.23 | 13 | 0.76 | 2 |
| Al—SiC | 0.50 | 2 | 0.66 | 14 | 0.63 | 3 |
| Si—SiC | 0.41 | 2 | 0.57 | 11 | 0.55 | 2 |

As can be seen from Table 5, there is a smaller increase in the warping when a heat generating element (conductive layer) is formed on the side of the surface opposite the side on which the conductive film is formed. Also, it is clear that performing heating by using the conductive layer as a heat generating element results in more-uniform heating.

### EMBODIMENT 6

Substrates made of aluminum nitride (AlN), silicon nitride (Si₃N₄), silicon carbide (SiC), alumina (Al₂O₃), a composite of aluminum and silicon carbide (Al—SiC), a composite of silicon and silicon carbide (Si—SiC), carbon (C), and zirconia (Zr) were provided, each measuring 40 mm on a side and having a thickness of 2 mm. Titanium was sprayed on these substrates by the low-pressure plasma spraying so as to form a thickness of 100 μm, and then nickel was formed by arc spraying thereon so as to have a thickness of 100 μm (Ti/Ni). Also, aluminum or copper was sprayed in the same manner as in Embodiment 1 so as to form a thickness of 100 μm, and then nickel was formed thereon by the arc spraying so as to have a thickness of 100 μm (Al/Ni, Cu/Ni). More nickel was formed thereon by the arc spraying so as to have a thickness of 100 μm (Ni). Also, stainless steel was formed by the flame spraying so as to have a thickness of 100 μm, and then nickel was formed thereon by the arc spraying so as to have a thickness of 100 μm (SUS/Ni).

A nickel-plated Kovar lead frame with a width of 5 mm, a length of 30 mm, and a thickness of 0.2 mm was soldered onto these conductive films. The adhesion strength between the conductive films and the substrates was measured by pulling the lead frames in a vertical direction. The results are shown in Table 6. In table 6, the sign ⊚ indicates that the substrate broke without the sprayed film peeling, and the numbers indicate the tensile strength (MPa) when the sprayed conductive film peeled.

TABLE 6

| Substrate material | Ti/Ni | Al/Ni | Cu/Ni | Ni | SUS/Ni |
|---|---|---|---|---|---|
| AlN | 32 | ⊚ | ⊚ | 19 | 28 |
| Si₃N₄ | 33 | ⊚ | ⊚ | 18 | 26 |
| SiC | 31 | ⊚ | ⊚ | 17 | 27 |
| Al₂O₃ | 28 | ⊚ | ⊚ | 18 | 25 |
| Al—SiC | 34 | ⊚ | ⊚ | 16 | 26 |
| Si—SiC | 36 | ⊚ | ⊚ | 17 | 27 |
| Carbon | 22 | 8 | 7 | 4 | 18 |
| Zirconia | 40 | 12 | 9 | 11 | 34 |

As can be seen from Table 6, excellent adhesiveness in which no peeling occurs until the substrate breaks is ensured when aluminum and copper are bonded to the substrate, and when the substrate material contains aluminum or silicon. Also, if titanium or stainless steel is bonded to the substrate, comparatively satisfactory adhesion strength is exhibited with any substrate, because these metals are active.

### EMBODIMENT 7

Substrates with shapes similar to those in Embodiment 1 were provided, and conductive films of the materials shown in Table 7 were sprayed, as in Embodiment 6. In Table 7, the numbers indicate the thicknesses (mm) of the materials. A cycle test was conducted to determine the number of cycles it takes for the conductive film to peel, up to 100 cycles. In each cycle, these metallized substrates were first left to stand for two hours in a desiccator at 200° C., and then for another two hours at room temperature. The results are shown in Table 8. In Table 8, the sign ⊚ indicates that the conductive film did not peel after 100 cycles. The sign - indicates that the film had poor adhesion and peeled either before the cycle test or after only one cycle.

TABLE 7

| No. | Material (thickness mm) |
|---|---|
| 1 | Ti (0.5)/Ni (0.5) |
| 2 | Ti (1.0)/Ni (0.5) |
| 3 | Ni (1.0) |
| 4 | Ni (1.5) |
| 5 | Cu (0.5)/Ni (1.0) |
| 6 | Al (1.5) |
| 7 | Cu (1.5) |
| 8 | Al (0.5)/SUS (1.0) |
| 9 | SUS (1.0) |
| 10 | SUS (1.5) |

TABLE 8

| Substrate | | | | | | | | | | |
|---|---|---|---|---|---|---|---|---|---|---|
| material | 1 | 2 | 3 | 4 | 5 | 6 | 7 | 8 | 9 | 10 |
| AlN | ⊚ | 11 | ⊚ | 21 | ⊚ | ⊚ | ⊚ | ⊚ | ⊚ | 25 |
| Si₃N₄ | ⊚ | 7 | ⊚ | 12 | ⊚ | ⊚ | ⊚ | ⊚ | ⊚ | 18 |
| SiC | ⊚ | 8 | ⊚ | 12 | ⊚ | ⊚ | ⊚ | ⊚ | ⊚ | 16 |
| Al₂O₃ | ⊚ | 10 | ⊚ | 16 | ⊚ | ⊚ | ⊚ | ⊚ | ⊚ | 29 |
| Al—SiC | ⊚ | 12 | ⊚ | 23 | ⊚ | ⊚ | ⊚ | ⊚ | ⊚ | 23 |
| Si—SiC | ⊚ | 7 | ⊚ | 10 | ⊚ | ⊚ | ⊚ | ⊚ | ⊚ | 13 |
| Carbon | ⊚ | 7 | — | — | — | — | — | — | — | — |
| Zirconia | ⊚ | 6 | ⊚ | 9 | ⊚ | ⊚ | ⊚ | ⊚ | ⊚ | 11 |

It is clear from these results that if the thickness of the conductive film is 1.0 mm or less, no peeling occurs even after 100 cycles, except with a carbon substrate. Even when the thickness exceeds 1.0 mm, the peeling occur does not after 100 cycles if copper, aluminum, or another such soft metal is bonded to the substrate.

### EMBODIMENT 8

Conductive films of varying thicknesses as shown in Table 9 were formed, and a cycle test was conducted at 400° C., as in Embodiment 7. The results are shown in Table 10.

TABLE 9

| No. | Material (thickness mm) |
|---|---|
| 1 | Ti (0.1)/Ni (0.2) |
| 2 | Ti (0.1)/Ni (0.3) |
| 3 | Ni (0.3) |
| 4 | Ni (0.4) |
| 5 | Cu (0.1)/Ni (0.3) |
| 6 | Al (0.5) |
| 7 | Cu (0.5) |
| 8 | Al (0.1)/SUS (0.3) |
| 9 | SUS (0.3) |
| 10 | SUS (0.4) |

TABLE 10

| Substrate | | | | | | | | | | |
|---|---|---|---|---|---|---|---|---|---|---|
| material | 1 | 2 | 3 | 4 | 5 | 6 | 7 | 8 | 9 | 10 |
| AlN | ⊚ | 38 | ⊚ | 48 | ⊚ | ⊚ | ⊚ | ⊚ | ⊚ | 62 |
| Si₃N₄ | ⊚ | 19 | ⊚ | 23 | ⊚ | ⊚ | ⊚ | ⊚ | ⊚ | 41 |
| SiC | ⊚ | 22 | ⊚ | 27 | ⊚ | ⊚ | ⊚ | ⊚ | ⊚ | 46 |
| Al₂O₃ | ⊚ | 47 | ⊚ | 54 | ⊚ | ⊚ | ⊚ | ⊚ | ⊚ | 71 |
| Al—SiC | ⊚ | 36 | ⊚ | 39 | ⊚ | ⊚ | ⊚ | ⊚ | ⊚ | 53 |
| Si—SiC | ⊚ | 10 | ⊚ | 15 | ⊚ | ⊚ | ⊚ | ⊚ | ⊚ | 20 |
| Carbon | ⊚ | 18 | — | — | — | — | — | — | — | — |
| Zirconia | ⊚ | 16 | ⊚ | 19 | ⊚ | ⊚ | ⊚ | ⊚ | ⊚ | 24 |

It is clear from these results that in a cycle test at 400° C., the conductive film is likely to peel when the thickness exceeds 0.3 mm.

### EMBODIMENT 9

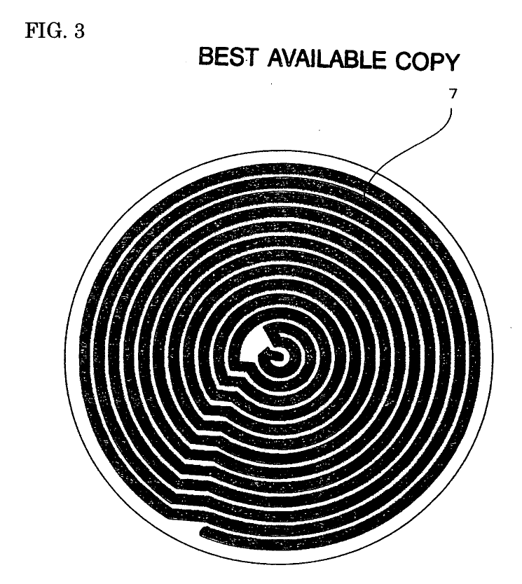

A substrate similar to the Si—SiC substrates used in Embodiment 1 was provided, and a whirling circuit pattern 7 as shown in FIG. 3 was formed. The circuit pattern was formed by the arc spraying with nickel.

The circuit resistance value after the spraying was measured, a heat treatment was performed at 700° C. in an atmosphere of hydrogen, and changes in the circuit resistance value and changes in the outward appearance were observed. As a result, the resistance value after the spraying was 24 Ω and the outward appearance had a slightly goldenrod color, but after the heat treatment, the heat resistance value was 22 Ω, and the outward appearance was silver gray in color and lustrous. It was confirmed that the resistance value decreased as a result of conducting the heat treatment in an atmosphere of hydrogen.

### EMBODIMENT 10

A substrate similar to the AlN substrate used in Embodiment 1 was provided, and a whirling circuit pattern as shown in FIG. 3 was formed. The circuit pattern was formed by the flame spraying with silver. After the circuit resistance value after the spraying was measured, a heating treatment was performed at 700° C. in at atmosphere of nitrogen with a dew point of −30° C., and changes in the circuit resistance value and the outward appearance of the conductive films were observed. As a result, the resistance value after the spraying was 13 Ω and the outward appearance had a thick brown color with dullness, but after the heat treatment, the heat resistance value was 12 Ω and the outward appearance had a clear metallic luster. It was confirmed that the resistance value decreased as a result of conducting a heat treatment in an atmosphere of an inert gas with a dew point of −30° C. or less. When the same metallized substrates were subjected to a heat treatment at 700° C. in an atmosphere of nitrogen with a dew point of +20° C., the resistance value and the outward appearance did not change.

### INDUSTRIAL APPLICABILITY

According to the present invention, a conductive film is formed by spraying on a ceramic substrate or a composite substrate of a ceramic and a metal, allowing a metallized substrate with a fine and smooth surface to be obtained. If a workpiece such as a wafer is mounted on such a metallized substrate, the adhesiveness between the metallized substrate and the workpiece improves. Therefore, if the metallized substrate of the present invention is used in the workpiece support of a semiconductor manufacturing device or in a semiconductor testing device that must requires uniform heating or must hold a wafer or the like by suction, the adhesiveness and the heating uniformity of the workpiece can be improved. Therefore, the throughput or the performance in the film forming, etching, testing, or the like can be improved.

What is claimed is:

1. A metallized substrate, in which a conductive film is formed by spraying on a surface of a ceramic substrate or a composite substrate of a ceramic and a metal.

2. The metallized substrate as described in claim 1, wherein a surface roughness of the conductive film formed by the spraying is Ra≦1.0 μm.

3. The metallized substrate as described in claim 1, wherein the spraying used is one of arc spraying, plasma spraying, and flame spraying.

4. The metallized substrate as described in claim 1, wherein a main component of the conductive film is one or more of nickel, aluminum, copper, titanium, stainless steel, gold, platinum, and silver.

5. The metallized substrate as described in claim 1, wherein the conductive film includes two or more stacked layers of sprayed films.

6. The metallized substrate as described in claim 1, wherein the conductive film is subjected to a heat treatment after being formed.

7. The metallized substrate as described in claim 6, wherein an atmosphere in which the heat treatment is conducted is a nonoxidizing atmosphere.

8. The metallized substrate as described in claim 1, wherein the ceramic is any of aluminum nitride, aluminum oxide, silicon nitride, and silicon carbide.

9. The metallized substrate as described in claim 1, wherein the composite of the ceramic and the metal is either a composite of silicon carbide and aluminum or a composite of silicon and silicon carbide.

10. The metallized substrate as described in claim 1, wherein a plating film is formed on the conductive film.

11. The metallized substrate as described in claim 10, wherein a surface roughness of the plating film is Ra≦1.0 μm.

12. The metallized substrate as described in claim 1, wherein a through-hole is formed in the substrate.

13. The metallized substrate as described in claim 1, wherein a groove is formed in the substrate.

14. The metallized substrate as described in claim 1, wherein a conductive layer is formed either on a surface of the substrate opposite the surface on which the conductive film is formed, or in an interior of the substrate.

15. The metallized substrate as described in claim 14, wherein the conductive layer is a heating element.

16. The metallized substrate as described in claim 1, wherein the metallized substrate is used in a semiconductor manufacturing device or a semiconductor testing device.

17. The metallized substrate as described in claim 16, wherein the metallized substrate is used in a wafer prober for heating and testing wafers.
